(19) United States
(12) Patent Application Publication
(10) Pub. No.: US 2021/0149943 A1
(43) Pub. Date: May 20, 2021

(54) SYSTEMS, DEVICES, AND METHODS FOR ENABLING A USER TO EXPLORE AND ACCESS ENTERTAINMENT ASSETS AT MULTIPLE MEDIA SERVICES

(71) Applicant: Alexis Hoy, Guelph (CA)

(72) Inventor: Alexis Hoy, Guelph (CA)

(21) Appl. No.: 16/951,962

(22) Filed: Nov. 18, 2020

Related U.S. Application Data
(60) Provisional application No. 62/937,179, filed on Nov. 18, 2019.

(51) Int. Cl. G06F 16/44; G06F 16/438; G06F 21/31

(52) U.S. Cl. CPC G06F 16/444; G06F 21/31; G06F 16/438

(57) ABSTRACT

Systems, devices, and methods that enable a user to explore the respective libraries of entertainment assets available at multiple media services are described. The user is also enabled to easily access a selected entertainment asset from any one of the multiple media services. The media services include online service providers such as streaming video providers and the entertainment assets include media such as movies and television shows. An aggregate library of entertainment assets is amassed that combines the respective libraries of entertainment assets from multiple media sources and the user is enabled to explore the aggregate library. An Aggregate library may comprise multiple different asset types, such as video, audio, game, literary, and so on. Annotations denote the media service(s) at which each entertainment asset is/are accessible and also indicate when the user is not authenticated to access a particular entertainment asset at a particular media source.

### CROSS-REFERENCE TO RELATED APPLICATION

This application claims the benefit of U.S. Provisional Patent Application Ser. No. 62/937,179, filed Nov. 18, 2019, the content of which is incorporated herein by reference in its entirety.

### BACKGROUND

### Technical Field

The present systems, devices, and methods generally relate to exploring and accessing entertainment assets, and particularly relate to enabling a user to explore and access entertainment assets at multiple remotely-located media services.

### Description of the Related Art

### Entertainment Assets

Throughout this specification and the appended claims, the term “entertainment asset” is used to broadly and generally refer to any instance of digital or electronic content of any nature that is typically used or consumed for entertainment purposes. Examples of entertainment assets include, without limitation: movies, books (e-books), television shows, magazines (e-magazines), videos, podcasts, audiobooks, songs, musical compositions, musical albums, video games, images, software, and radio shows.

### Media Services

A media service (or sometimes “digital media service”) is an online service that provides access to digital and/or electronic content, such as entertainment assets. A media service may hold a library of entertainment assets and provide (e.g., sell) access to such entertainment assets in a variety of different ways, including as downloadable content for a user to store and execute locally and/or as streamable content that is hosted by the media service and only viewed remotely by the user. An entity, organization, or application may operate as a media service as its primary or sole functionality or as part of a wider range of offerings. Common media services in the industry today include, without limitation: Netflix®, Amazon Prime®, Crave®, Disney+®, HBO Max®, Steam® by Valve Corporation, Spotify®, Apple TV+®, Apple Music®, iTunes Store®, Apple App Store®, Google Play®, Play Movies®, Play Music®, Tidal®, Apple Podcast®, Stitcher®, Overdrive®, Audible®, and so on, just to name a few. Additionally, individual television stations, channels, and/or networks typically provide media service functionality (e.g., Fox, ABC, Global, Comedy Central, and the like).

### BRIEF SUMMARY

A method of enabling a user to explore and access entertainment assets at multiple media services may be summarized as including: accessing a respective library of entertainment assets at each respective media service in a set of media services; displaying to the user at least a portion of an aggregate library of entertainment assets, the aggregate library of entertainment assets including each respective library of entertainment assets at each respective media service in the set of media services; receiving from the user a selection of a particular entertainment asset from the aggregate library of entertainment assets; and accessing the particular entertainment asset at a particular media service in the set of media services, the particular media service having a library of entertainment assets that includes the particular entertainment asset. The method may further include receiving a query from the user and retrieving at least one result of the query from the aggregate library of entertainment assets.

Accessing the particular entertainment asset at a particular media service in the set of media services may include opening an application corresponding to the particular media service and causing the application to access the particular entertainment asset. With or without opening an application corresponding to the particular media service, accessing the particular entertainment asset at a particular media service in the set of media services may include prompting the user to log in to or create an account at the particular media service.

The method may further include authenticating the user each media service in the set of media services. Additionally, the method may further include accessing at least one additional library of entertainment assets of at least one media service at which the user is not authenticated, wherein the aggregate library of entertainment assets further includes the at least one additional library of entertainment assets at the at least one media service at which the user is not authenticated. Displaying to the user at least a portion of an aggregate library of entertainment assets may include: displaying to the user at least one entertainment asset accessible at a media service at which the user is not authenticated; and annotating the at least one entertainment asset accessible at a media service at which the user is not authenticated with an identification of the media service at which the at least one entertainment asset is accessible. Receiving from the user a selection of a particular entertainment asset from the aggregate library of entertainment assets may include receiving from the user a selection of an entertainment asset accessible at a media service at which the user is not authenticated, and the method may further include prompting the user to log in to or create an account at the media service at which the user is not authenticated. Receiving from the user a selection of a particular entertainment asset from the aggregate library of entertainment assets may include receiving from the user a selection of an entertainment asset accessible at a media service at which the user is authenticated, and the method may further include providing the particular entertainment asset to the user.

At least one entertainment asset may be selected from a group consisting of: a movie, a video, a television show, a game, a song, a musical composition, a musical album, a book, a podcast, and a magazine.

Accessing a respective library of entertainment assets at each respective media service in a set of media services may include accessing a first library of entertainment assets of a first type (e.g., video assets) at a first media service and accessing a second library of entertainment assets of a second type (e.g., music assets) at a second media service, the second type of entertainment assets different from the first type of entertainment assets such that the aggregate library of entertainment assets includes at least two different asset types.

A system for enabling a user to explore and access entertainment assets at multiple media services may be summarized as including: at least one processor; a display communicatively coupled to the at least one processor; a communication interface communicatively coupled to the at least one processor; and a non-transitory processor-readable storage medium communicatively coupled to the at least one processor, the non-transitory processor-readable storage medium storing data and/or processor-executable instructions that, when executed by the at least one processor, cause: the communication interface to access a respective library of entertainment assets at each respective media service in a set of media services; the display to display to the user at least a portion of an aggregate library of entertainment assets, the aggregate library of entertainment assets including each respective library of entertainment assets at each respective media service in the set of media services; and in response to receiving from the user a selection of a particular entertainment asset from the aggregate library of entertainment assets: the communication interface to access the particular entertainment asset at a particular media service in the set of media services, the particular media service having a library of entertainment assets that includes the particular entertainment asset. The data and/or processor-executable instructions, when executed by the at least one processor, may further cause, in response to receiving a query from the user, the communication interface to retrieve at least one result of the query from the aggregate library of entertainment assets.

The non-transitory processor-readable storage medium may further store a respective application corresponding to each respective media service in the set of media services. The data and/or processor-executable instructions that, when executed by the at least one processor, cause the communication interface to access the particular entertainment asset at a particular media service in the set of media services, may further cause: the system to open a particular application corresponding to the particular media service; and the particular application to access the particular entertainment asset. The data and/or processor-executable instructions that, when executed by the at least one processor, cause the communication interface to access the particular entertainment asset at a particular media service in the set of media services, may further cause the display to prompt the user to log in to or create an account at the particular media service.

The data and/or processor-executable instructions, when executed by the at least one processor, may further cause the system to authenticate the user at each media service in the set of media services. The data and/or processor-executable instructions, when executed by the at least one processor, may further cause the communication interface to access at least one additional library of entertainment assets of at least one media service at which the user is not authenticated, wherein the aggregate library of entertainment assets further includes the at least one additional library of entertainment assets at the at least one media service at which the user is not authenticated. The data and/or processor-executable instructions that, when executed by the at least one processor, cause the display to display to the user at least a portion of an aggregate library of entertainment assets, may cause the display to: display to the user at least one entertainment asset accessible at a media service at which the user is not authenticated; and annotate the at least one entertainment asset accessible at a media service at which the user is not authenticated with an identification of the media service at which the at least one entertainment asset is accessible. In response to receiving from the user a selection of an entertainment asset accessible at a media service at which the user is not authenticated, the data and/or processor-executable instructions, when executed by the at least one processor, may cause the display to prompt the user to log in to or create an account at the media service at which the user is not authenticated. In response to receiving from the user a selection of an entertainment asset accessible at a media service at which the user is authenticated, the data and/or processor-executable instructions, when executed by the at least one processor, may cause the system to provide the particular entertainment asset to the user.

The data and/or processor-executable instructions, when executed by the at least one processor, may cause the communication interface to access a first library of entertainment assets of a first type (e.g., podcast assets) at a first media service and access a second library of entertainment assets of a second type (e.g., audiobook assets) at a second media service, the second type of entertainment assets different from the first type of entertainment assets such that the aggregate library of entertainment assets includes at least two different asset types.

A computer program product may be summarized as including: processor-executable instructions and/or data that, when the computer program product is: stored in a non-transitory processor-readable storage medium of a system comprising: at least one processor; a display communicatively coupled to the at least one processor; a communication interface communicatively coupled to the at least one processor; and the non-transitory processor-readable storage medium communicatively coupled to the at least one processor; and executed by the at least one processor, cause: the communication interface to access a respective library of entertainment assets at each respective media service in a set of media services; the display to display to the user at least a portion of an aggregate library of entertainment assets, the aggregate library of entertainment assets including each respective library of entertainment assets at each respective media service in the set of media services; and in response to receiving from the user a selection of a particular entertainment asset from the aggregate library of entertainment assets: the communication interface to access the particular entertainment asset at a particular media service in the set of media services, the particular media service having a library of entertainment assets that includes the particular entertainment asset. The data and/or processor-executable instructions of the computer program product, when executed by the at least one processor, may further cause, in response to receiving a query from the user, the communication interface to retrieve at least one result of the query from the aggregate library of entertainment assets.

The data and/or processor-executable instructions of the computer program product that, when executed by the at least one processor, cause the communication interface to access the particular entertainment asset at a particular media service in the set of media services, may further cause: the computer program product to open an application corresponding to the particular media service; and the application to access the particular entertainment asset.

The data and/or processor-executable instructions of the computer program product that, when executed by the at least one processor, cause the communication interface to access the particular entertainment asset at a particular media service in the set of media services, may further cause the display to prompt the user to log in to or create an account at the particular media service.

The data and/or processor-executable instructions of the computer program product, when executed by the at least one processor, may further cause the system to authenticate the user at each media service in the set of media services. The data and/or processor-executable instructions of the computer program product, when executed by the at least one processor, may further cause the communication interface to access at least one additional library of entertainment assets of at least one media service at which the user is not authenticated, wherein the aggregate library of entertainment assets further includes the at least one additional library of entertainment assets at the at least one media service at which the user is not authenticated. The data and/or processor-executable instructions of the computer program product that, when executed by the at least one processor, cause the display to display to the user at least a portion of an aggregate library of entertainment assets, may cause the display to: display to the user at least one entertainment asset accessible at a media service at which the user is not authenticated; and annotate the at least one entertainment asset accessible at a media service at which the user is not authenticated with an identification of the media service at which the at least one entertainment asset is accessible. In response to receiving from the user a selection of an entertainment asset accessible at a media service at which the user is not authenticated, the data and/or processor-executable instructions of the computer program product, when executed by the at least one processor, may cause the display to prompt the user to log in to or create an account at the media service at which the user is not authenticated. In response to receiving from the user a selection of an entertainment asset accessible at a media service at which the user is authenticated, the data and/or processor-executable instructions of the computer program product, when executed by the at least one processor, may cause the system to provide the particular entertainment asset to the user.

### BRIEF DESCRIPTION OF THE SEVERAL VIEWS OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1 is a flow diagram showing an exemplary method of enabling a user to explore and access entertainment assets at multiple media services in accordance with the present systems, devices, and methods.

FIG. 2 is a flow diagram showing another exemplary method of enabling a user to explore and access entertainment assets at multiple media services in accordance with the present systems, devices, and methods.

FIG. 3 is a flow diagram showing another exemplary method of enabling a user to explore and access entertainment assets at multiple media services in accordance with the present systems, devices, and methods.

FIG. 4 is a flow diagram showing an exemplary method of enabling a user to explore and access entertainment assets at multiple media services, with certain media services requiring authentication, in accordance with the present systems, devices, and methods.

FIG. 5 is an illustrative diagram of a user interface that demonstrates an exemplary instance of the present systems, devices, and methods.

FIG. 6 is an illustrative diagram of another user interface that demonstrates another exemplary instance of the present systems, devices, and methods.

FIG. 7 is an illustrative diagram of another user interface that demonstrates another exemplary instance of the present systems, devices, and methods.

FIG. 8 is an illustrative diagram of a processor-based computer system suitable at a high level for enabling a user to explore and access entertainment assets at multiple media services in accordance with the present systems, devices, and methods.

### DETAILED DESCRIPTION

The following description sets forth specific details in order to illustrate and provide an understanding of the various implementations and embodiments of the present systems, devices, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present systems, devices, and methods.

The various embodiments described herein provide systems, devices, and methods for enabling a user to explore and access entertainment assets at multiple media services. Users and enjoyers of entertainment assets today are faced with a large and ever-growing number of available media services from which to choose, each with their own respective library of entertainment assets. There may be overlap between the various libraries such that, for certain entertainment assets, the same entertainment asset may be available at more than one media service. Conversely, there may be certain entertainment assets that are only exclusively available from one media service. In order to explore the entertainment assets available at a particular media service, a user is typically required to access the library of the particular media service directly through a website or software application provided by the particular media service. The website or software application of a first media service does not typically permit or enable a user to explore or access the library of entertainment assets available at a second media service. Therefore, in order to locate and access a particular entertainment asset (e.g., a movie “X”), a user today typically activates a first website or software application corresponding to a first media service (e.g., Netflix) and queries within such first website or first software application to attempt to locate the particular entertainment asset X in the library of the first media service. If the particular entertainment asset X is not found in the library of the first media service, the user moves on to activate a second website or software application corresponding to a second media service (e.g., Amazon Prime) and queries within such second website or second software application to attempt to locate the particular entertainment asset X in the library of the second media service. This tedious process may continue through any number of media services and can be quite time consuming, especially as more and more new media services continue to be introduced. Furthermore, even if the user is not searching for a particular entertainment asset but just wants to review the offerings in a particular genre or category, the current state of the art only permits the user to similarly review the respective libraries of multiple media assets individually and one at a time.

The limitations described above result in a sub-optimal entertainment asset distribution system marred by an overall unpleasant user experience. There is a need in the art for efficient mechanisms of exploring and accessing entertainment assets across multiple media services. The various embodiments described herein address this need by providing systems, devices, and methods that enable a user to explore the respective libraries of entertainment assets available at multiple media services substantially concurrently and to access a selected entertainment asset from any one of the multiple media services.

Throughout this specification and the appended claims, the term “explore” is used to generally refer to the act or process of navigating, searching, and/or perusing through a set of options or choices. Thus, the phrase “explore a library of entertainment assets” may generally mean to, for example, navigate, search through, or peruse the library of entertainment assets. A library of entertainment assets may be explored with a particular intent, such as to evaluate the scope or quality of the library of entertainment assets and/or to locate or select a particular entertainment asset from the library of entertainment assets.

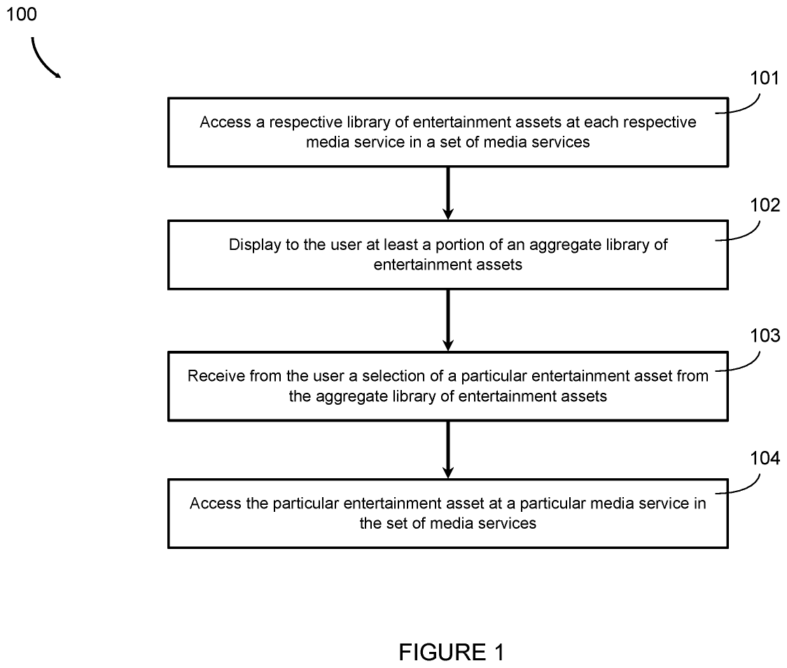

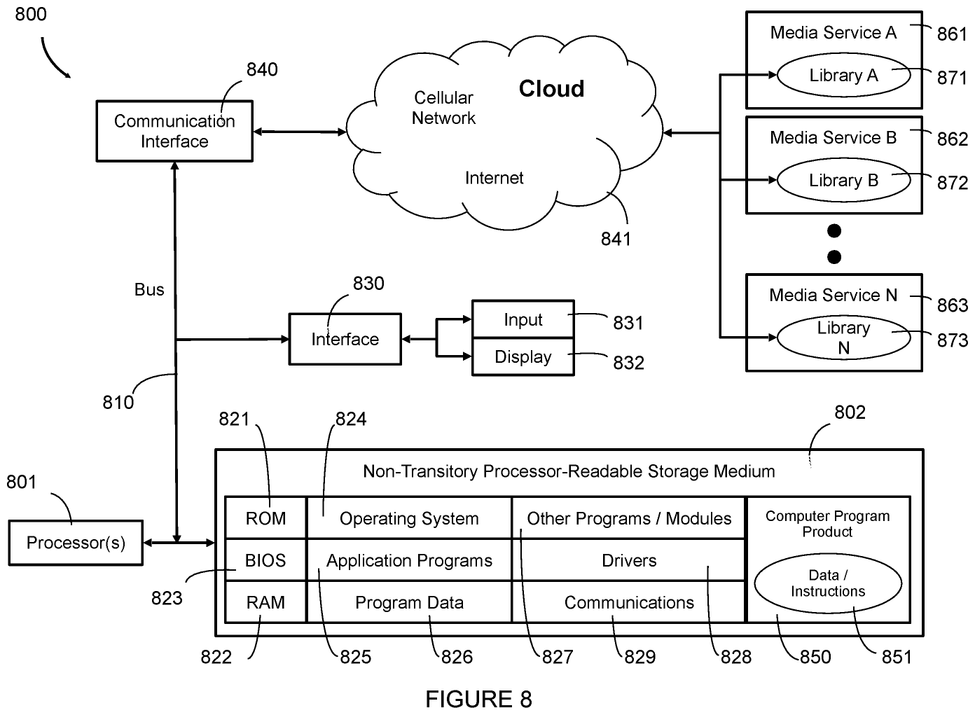

FIG. 1 is a flow diagram showing an exemplary method 100 of enabling a user to explore and access entertainment assets at multiple media services in accordance with the present systems, devices, and methods. In some implementations, method 100 may be a computer-implemented method. In general, throughout this specification and the appended claims, a computer-implemented method is a method in which the various acts are performed by one or more processor-based computer system(s). For example, certain acts of a computer-implemented method may be performed by at least one processor communicatively coupled to at least one non-transitory processor-readable storage medium or memory (hereinafter referred to as a non-transitory processor-readable storage medium) and, in some implementations, certain acts of a computer-implemented method may be performed by peripheral components of the computer system that are communicatively coupled to the at least one processor, such as interface devices, sensors, communications and networking hardware, and so on. The non-transitory processor-readable storage medium may store data and/or processor-executable instructions that, when executed by the at least one processor, cause the computer system to perform the computer-implemented method and/or cause the at least one processor to perform those acts of the method that are performed by the at least one processor. FIG. 8, and the written descriptions thereof, provide illustrative examples of computer systems that are suitable to perform the computer-implemented methods described herein.

Returning to FIG. 1, method 100 includes four acts 101, 102, 103, and 104, though those of skill in the art will appreciate that in alternative implementations certain acts may be omitted and/or additional acts may be added. Those of skill in the art will also appreciate that the illustrated order of the acts is shown for exemplary purposes only and may change in alternative implementations.

At 101, a respective library of entertainment assets is accessed at each respective media service in a set of media services. For example, a set of streaming video service providers (e.g., Netflix, Amazon Prime, Disney+, and the like) may be identified and a respective library of video entertainment (e.g., movies, television shows, documentaries, and the like) may be accessed at each respective streaming video service provider in the set of streaming video service providers. Similarly, a set of streaming music service providers (e.g., Spotify, Apple Music, Tidal, and the like) may be identified and a respective library of musical entertainment (e.g., songs, albums, musical compositions, and the like) may be accessed at each respective streaming music service provider in the set of streaming music service providers. In some implementations, the set of media services may include online service providers having libraries of different entertainment asset types, such as streaming video service providers and streaming music service providers. In some implementations (e.g., in implementations in which method 100 is a computer-implemented method), a respective library of entertainment assets at each respective media service in the set of media services may be accessed by at least one processor, or by a communication interface communicatively coupled to at least one processor, in a computer system such as a laptop computer, a desktop computer, a tablet computer, a smartphone, a smart tv, or a digital media player (e.g., an Apple TV, a Google Chromecast, an Amazon Fire TV, or a Roku player).

The composition or constituents of the set of media services accessed at 101 may be determined in a variety of ways. For example, a user may be presented with a checklist of candidate media services and the user may select which media services are to be accessed at 101. Alternatively, a pre-set or default combination of media services may be provided. In some implementations, the user may select or otherwise indicate the type of asset they wish to access (e.g., video, audiobook, game, and so on).

At 102, at least a portion of an aggregate library of entertainment assets is displayed to the user. The aggregate library of entertainment assets may include a combination, amalgamation, or generally aggregation of the respective libraries of entertainment assets accessed at 101. The at least a portion of the aggregate library of entertainment assets may be displayed to the user by at least one display, such as (depending on the specific implementation) a computer display, a monitor, a television screen, a smart television screen, a tablet screen, a smartphone screen, or generally any screen/display/monitor communicatively coupled to a system that is configured to implement the present systems, devices, and methods. A person of skill in the art will appreciate an aggregate library of entertainment assets comprising the respective libraries of multiple media services (such as the combination of the library of entertainment assets at Netflix, the library of entertainment assets at Amazon Prime, the library of entertainment assets at Apple TV+, and the library of entertainment assets at HBO Max) may comprise a large number of entertainment assets. Thus, at 102 only a portion of the aggregate library of entertainment assets may be displayed to the user, such portion corresponding to a subset of entertainment assets that may match some categorization, filter, search, or query criteria. For example, at 102 a subset of entertainment assets corresponding to one or more particular genre(s), release date(s), character(s), artist(s)/performer(s), or other property may be displayed.

Unless the specific context requires otherwise, throughout this specification and the appended claims to “display a library of entertainment assets,” and variations such as to “display a portion of a library of entertainment assets” and to “display a portion of an aggregate library of entertainment assets,” means to display the details and/or contents (or a portion of the contents) of the library of entertainment assets and not necessarily to provide, play, open, or execute any particular entertainment asset. For example, if the library of entertainment assets comprises a set of movies and television shows, then the “display the library of entertainment assets” means to display a list, itemization, tiling, tessellation, or other representation of the identities (e.g., titles) of the movies and television shows in the library without necessarily playing any particular one of the movies or television shows.

At 103, a selection of a particular entertainment asset from the aggregate library of entertainment assets is received (e.g., by the system that is implementing method 100) from the user. Depending on the particular system that is implementing method 100, the selection of the particular entertainment asset may be received in any of a variety of different forms, including without limitation: as an infrared, radio frequency, or Bluetooth signal sent from an input device (such as a remote control) operated by the user and received by a receiver of the system operating method 100 (such receiver communicatively coupled to the at least one processor of the system implementing method 100 when method 100 is a computer-implemented method), as a voice command provided by the user and received by at least one microphone, as a keystroke on a keyboard or a click of a mouse button, or as an activation of a corresponding region on a touchscreen. Generally, the particular entertainment asset corresponding to the selection received from the user at 103 may be an entertainment asset from the portion of the aggregate library of entertainment assets displayed to the user at 102.

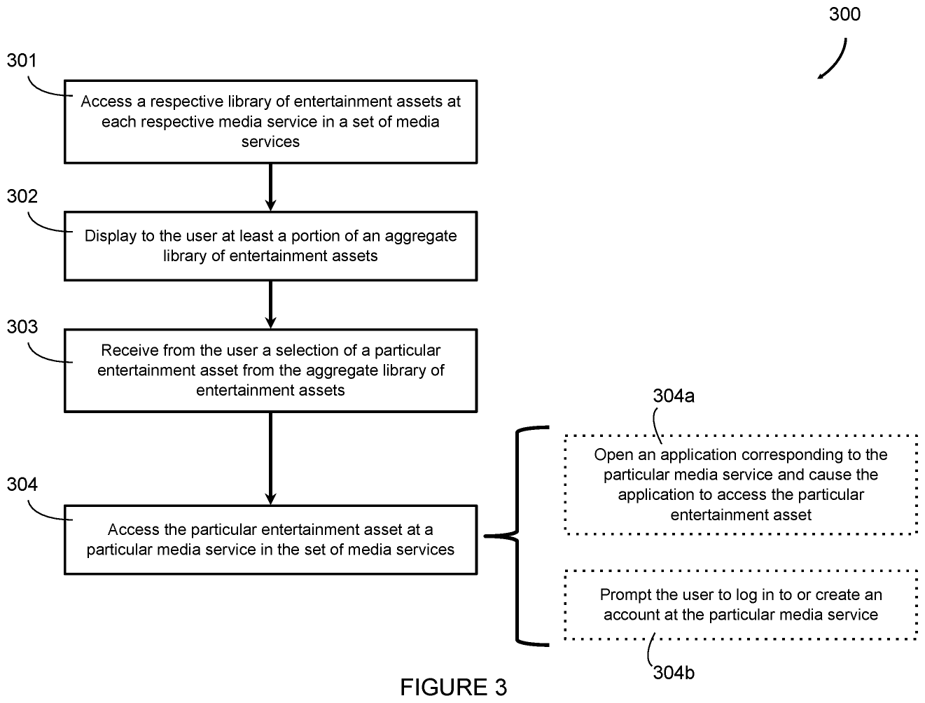

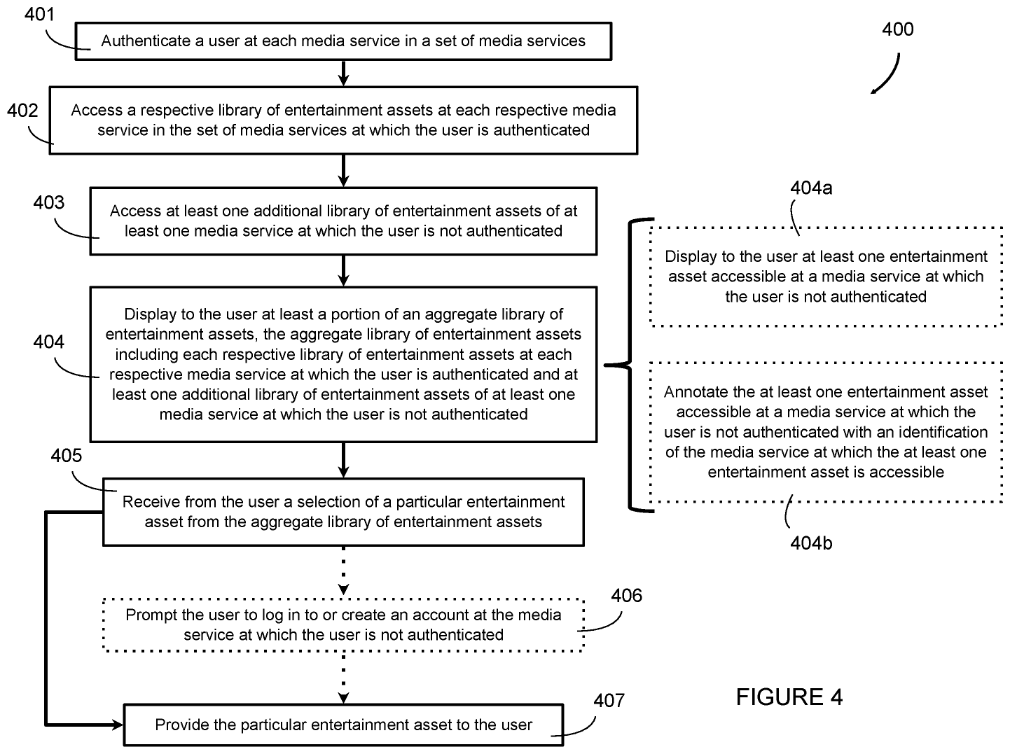

At 104, the particular entertainment asset corresponding to the selection received from the user at 103 is accessed at a particular media service in the set of media services. Accessing the particular entertainment asset may include providing the particular entertainment asset to the user. Further detail on how the particular asset may be accessed and/or provided to the user is described later on, for example, in relation to FIG. 3 and FIG. 4.

As described previously, the portion of the aggregate library of entertainment assets displayed at 102 may correspond to a subset of entertainment assets that may match some categorization, filter, search, or query criteria. In some implementations the portion of the aggregate library of entertainment assets displayed at 102 may be automatically generated by the system implementing method 100 (e.g., by the computer system implementing method 100 when method 100 is a computer-implemented method) and may include, for example, “New Releases,” “New Additions to the Aggregate Library,” “Recommendations/Suggestions” based on a user's history of entertainment assets accessed, and/or similar. In other implementations, the portion of the aggregate library of entertainment assets displayed at 102 may be generated in response to a search or query received from the user.

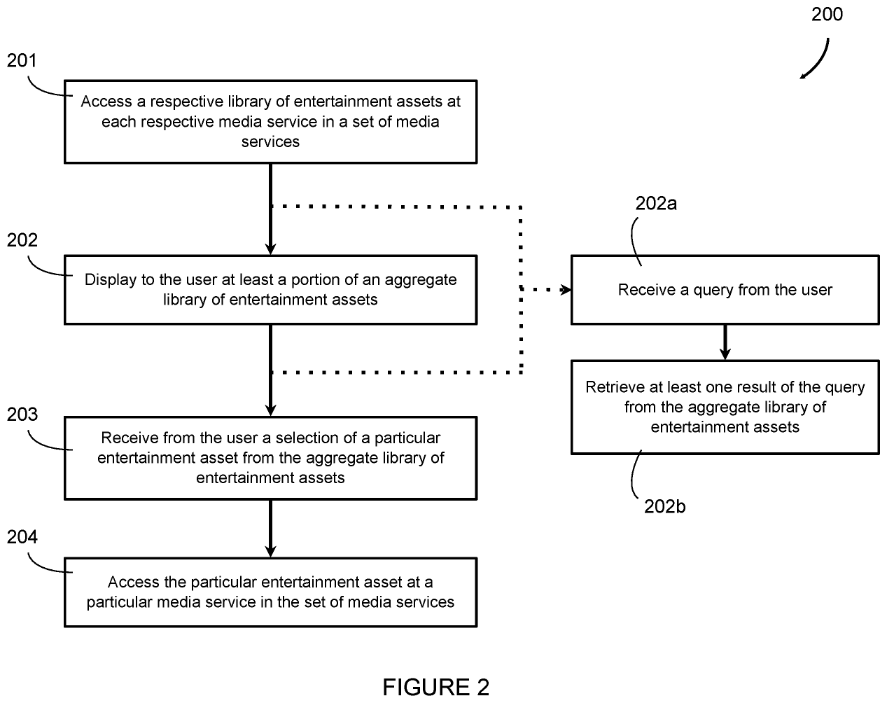

FIG. 2 is a flow diagram showing an exemplary method 200 of enabling a user to explore and access entertainment assets at multiple media services in accordance with the present systems, devices, and methods. Method 200 is substantially similar to method 100 from FIG. 1 but includes two additional acts. That is, method 200 includes act 201 that is substantially similar to act 101 from method 100, act 202 that is substantially similar to act 102 of method 100, act 203 that is substantially similar to act 103 of method 100, and act 204 that is substantially similar to act 104 of method 100; and method 200 also includes acts 202a and 202b that, depending on the specific implementation, may be performed before act 202, after act 202, or both before and after act 202.

At 202a, a query is received from the user. The query may be received from the user in a similar manner to how the selection is received from the user at act 103/203; that is, the query may be received from the user as an infrared or rf signal sent from a remote control, a voice command, one or more keyboard stroke(s), one or more mouse click(s), one or more touch screen activation(s), and the like. Depending on the specific implementation, the query may be directed towards any detail or aspect of any entertainment asset that may or may not be included in the aggregate library of entertainment assets. As examples, the query may be directed towards: a title of an entertainment asset (e.g., movie title, song title, etc.), a performer of or included in an entertainment asset (e.g., actor, singer, band name, author, etc.), a producer or other person involved in an entertainment asset (e.g., director, record label), a release date of an entertainment asset, and so on.

At 202b, at least one result of the query received at 202a is retrieved from the aggregate library of entertainment assets. The at least one result may include an exact match to the query and/or any number of approximate matches to the query. Depending on the specific implementation, retrieving the at least one result of the query at 202b may include either: a) searching through the aggregate library of entertainment assets to locate and access the at least one result of the query, or b) causing a separate system or application (e.g., a separate system or application corresponding to one or more media services) to locate the at least one result and receiving the at least one result from the separate system or application.

As illustrated in FIG. 2, acts 202a and 202b may be performed before act 202, after act 202, or both before and after act 202. When acts 202a and 202b are performed before act 202, the portion of the aggregate library of entertainment assets displayed at 202 may correspond to or include the at least one result of the query retrieved at 202b. When acts 202a and 202b are performed after act 202, the portion of the aggregate library of entertainment assets displayed at 202 may include an automatically generated subset of entertainment assets as previously described, and then retrieving the at least one result of the query at 202b may include displaying the at least one result of the query. A person of skill in the art will appreciate that any number of iterations of acts 202, 202a, and 202b may be performed.

At act 204 of method 200, similar to at act 104 of method 100, a particular entertainment asset that has been selected by the user is “accessed” at a particular media service in the set of media services. Unless the specific context requires otherwise, throughout this specification and the appended claims the term “access” generally means to “establish access to” through one or more communication channels such that the subject being accessed is, or may be, explored by, retrieved by, and/or provided to a user. Depending on the specific implementation of the present systems, devices, and methods, there are a variety of ways in which an entertainment asset may be “accessed.” Examples are provided throughout this description.

FIG. 3 is a flow diagram showing an exemplary method 300 of enabling a user to explore and access entertainment assets at multiple media services in accordance with the present systems, devices, and methods. Method 300 is substantially similar to method 200 from FIG. 2 and method 100 from FIG. 1 but includes two additional sub-acts. That is, method 300 includes act 301 that is substantially similar to act 201 from method 200 and act 101 from method 100, act 302 that is substantially similar to act 202 of method 200 and act 102 of method 100, act 303 that is substantially similar to act 203 of method 200 and act 103 of method 100, and act 304 that is substantially similar to act 204 of method 200 and act 104 of method 100; and act 304 of method 300 also includes sub-acts 304a and 304b, either or both of which may be performed as part of act 304 depending on the specific implementation.

At 304, the particular entertainment asset corresponding to the selection received from the user at 303 is accessed at a particular media service in the set of media services. In some implementations, accessing the particular entertainment asset at 304 may include sub-act 304a; in some implementations, accessing the particular entertainment asset at 304 may include sub-act 304b.

At 304a, a software application or program corresponding to the particular media service is opened or executed and the application is caused (e.g., instructed or operated) to access the particular entertainment asset. In this context, “causing” an application or program to access the particular entertainment asset may mean, for example, sending instructions or data to the application or program that result in the particular entertainment assets being accessed, executed, or opened within the application or program. As an example, if the particular entertainment asset is a particular movie and the particular media service at which the particular movie is accessed at 304 is, for example, Netflix, then at 304a a Netflix application or program is opened or executed and the particular movie is accessed, opened, or played from within the Netflix application or program.

At 304b, the user is prompted to log in to or create an account at the particular media service. As will be discussed in more detail in the context of FIG. 4, act 304 of method 300 generally only includes sub-act 304b if: a) the particular media service requires that a user log in to an account, or otherwise authenticate, before accessing entertainment assets, and b) the user has not already logged in or otherwise authenticated at the particular media service. In implementations in which act 304 includes sub-act 304a, at 304b the software application or program corresponding to the particular media service may prompt the user to log in or create an account at the particular media service.

While some media services do provide limited access to particular entertainment assets free of charge (such as certain television broadcast channels that provide streamable versions of certain shows online for a limited time after initial airing), most media services charge a subscription fee for access to their library of entertainment assets. In some cases, a media service may allow/permit an unauthenticated user to explore the library of entertainment assets accessible at the media service but restrict access to the entertainment assets such that only an authenticated user may actually access (e.g., open, execute, play, view, listen to, etc.) the entertainment assets.

FIG. 4 is a flow diagram showing an exemplary method 400 of enabling a user to explore and access entertainment assets at multiple media services, with certain media services requiring authentication, in accordance with the present systems, devices, and methods. In some implementations, method 400 may be a computer-implemented method. Method 400 includes seven acts 401, 402, 403, 404, 405, 406, and 407 and two sub-acts 404a, 404b, though those of skill in the art will appreciate that in alternative implementations certain acts and/or sub-acts may be omitted and/or additional acts and/or sub-acts may be added. Those of skill in the art will also appreciate that the illustrated order of the acts and sub-acts is shown for exemplary purposes only and may change in alternative implementations.

At 401, the user is authenticated at each media service in a set of media services. Such authentication may be carried out in series. For example, a user may select a first media service (e.g., Netflix) and enter his/her account credentials to log in to, or authenticate at, the first media service; the user may then select a second media service (e.g., Amazon Prime) and enter his/her account credentials to log in to, or authenticate at, the second media service; and so on for any number of media services. A person of skill in the art will appreciate that authentication may involve, for example, providing a previously established user name and password and/or exchanging one or more code(s) or key(s). Such authentication information may be stored and re-used such that the user does not need to perform the authentication at act 401 each time method 400 is performed. In implementations in which one or more media service(s) has a corresponding software application or program that will be opened or executed when an entertainment asset at such media service is accessed, the authentication at act 401 may be performed (and the authentication information may be stored) within, and/or retrieved from, the corresponding software application or program. However, as discussed in more detail later on, in some implementations a single “global” software application or program may explore and access multiple/all libraries of entertainment assets at which the user has accounts and, in such implementations, the authentication information may be entered and stored within the global software application or program.

At 402, a respective library of entertainment assets is accessed at each respective media service in the set of media services at which the user is authenticated. Act 402 of method 400 is substantially similar to act 101 of method 100, act 201 of method 200, and act 301 of method 300, with the added detail that at 402 of method 400 the respective libraries accessed are limited to those libraries of media services at which the user has authenticated (e.g., entered and stored authentication information) at 401.

At 403, at least one additional library of entertainment assets is accessed at at least one media service at which the user is not authenticated. In this context, to “access” a library of entertainment assets at a media service at which the user is not authenticated means to establish a communication channel through which the library of entertainment assets may be explored by the unauthenticated user, but to access a library of entertainment assets does not necessarily mean that individual entertainment assets themselves may be accessible by, retrievable by, or otherwise provided to the unauthenticated user. Thus, throughout this specification and the appended claims there is a distinction between “access” to a particular entertainment asset and “access” to a library of entertainment assets. Accessing a library of entertainment assets may, in some cases, be possible without having access to any particular entertainment asset. For example, in some cases a user may view/peruse/explore a catalog of entertainment asset offerings from a particular media service without having sufficient access privileges to actually employ/retrieve/play any particular entertainment asset in the library. “Accessing” a library of entertainment assets is analogous to, for example, a member of the public entering a public library or video rental store and exploring the assets available at such public library or video rental store. “Accessing” a particular entertainment asset is analogous to such member of the public actually borrowing/renting/purchasing, or otherwise obtaining a particular asset from such public library or video rental store. A person of skill in the art will appreciate that, generally, any member of the public may explore (i.e., “access”) the library of entertainment assets available at a public library or video rental store while only those individuals with sufficient authentication (e.g., a library card or a membership/account at the video rental store) may actually borrow/rent/purchase or otherwise obtain assets from a public library or video rental store.

At 404, at least a portion of an aggregate library of entertainment assets is displayed to the user similar to act 102 of method 100, act 202 of method 200, and act 302 of method 300, with the added detail that in method 400 the aggregate library of entertainment assets includes: a) each respective library of entertainment assets accessed (at 401) at each respective media service at which the user is authenticated, and b) at least one additional library of entertainment assets accessed (at 402) at at least one media service at which the user is not authenticated. Thus, in method 400 the aggregate library of entertainment assets includes entertainment assets that the user can access/retrieve/play as well as entertainment assets for which the user can identify the source (i.e., the corresponding media service at which the user is not authenticated) but which the user cannot actually access/retrieve/play. In some instances of method 400, all of the entertainment assets in the portion of the aggregate library of entertainment assets displayed at 404 may originate from (or be accessible at) a media service or media services at which the user is authenticated (i.e., all entertainment assets from the libraries of entertainment assets accessed at act 402), in which case method 400 does not include sub-acts 404a and 404b; however, in other instances of method 400, act 404 may include sub-acts 404a and 404b.

At 404a, one or more of the entertainment assets in the portion of the aggregate library of entertainment assets displayed at 404 originates from (or is accessible at) a media service at which the user is not authenticated (i.e., an entertainment asset from the library of entertainment assets accessed at 403). In other words, at 404 the portion of the aggregate library of entertainment assets displayed to the user may include at least one asset that the user can access/retrieve/play because the user is authenticated at the corresponding media service from which such entertainment asset is accessible/retrievable/playable, and at least one asset that the user cannot access/retrieve/play because the user is not authenticated at the corresponding media service from which such entertainment asset is accessible/retrievable/playable.

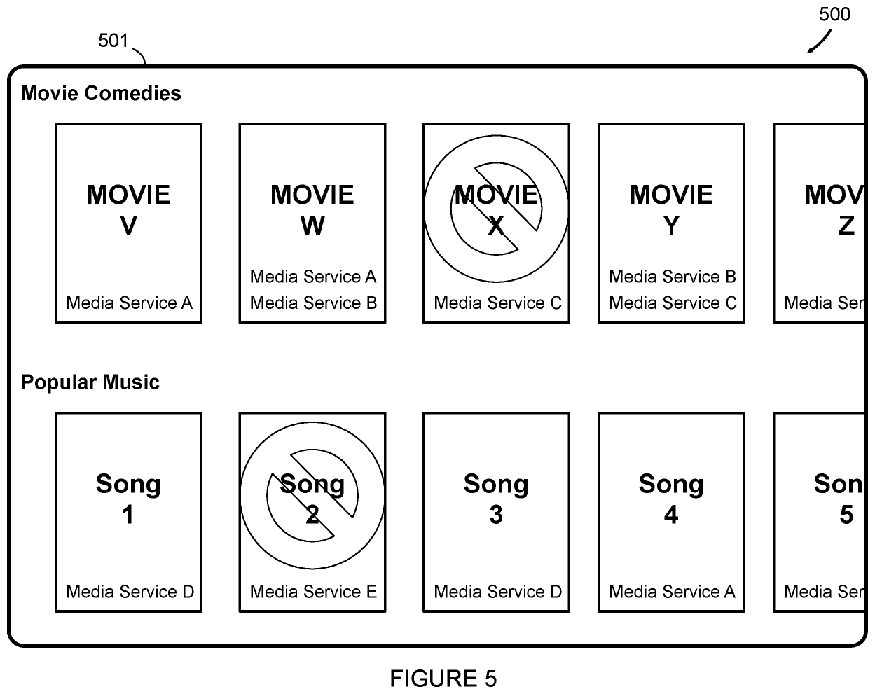

At 404b, the at least one entertainment asset accessible at a media service at which the user is not authenticated that is displayed at 404a is annotated with an identification of the media service at which the at least one entertainment asset is accessible and at which the user is not authenticated. In this context, the term “annotate” means that the at least one entertainment asset is marked, noted, or otherwise displayed in association with an indication (e.g., a visual indication) of the identity of the media service at which the at least one entertainment asset is accessible and at which the user is not authenticated. Either in addition to or instead of such identifying annotation, in some implementations the display of the at least one entertainment asset accessible at a media service at which the user is not authenticated may be annotated with a mark or indication that the at least one entertainment asset is currently not available to the user, such as a symbol or icon representing that the at least one entertainment asset is locked or inaccessible. More details of such annotations are described in the context of FIGS. 5, 6, and 7.

At 405, a selection of a particular entertainment asset from the aggregate library of entertainment assets is received from the user. Act 405 of method 400 is substantially similar to act 103 of method 100, act 203 of method 200, and act 303 of method 300. The particular entertainment asset selected by the user may be an entertainment asset to which the user does have access (i.e., an entertainment asset from a library of entertainment assets accessed, at 402, at a media service at which the user is authenticated) or the particular entertainment asset selected by the user may be an entertainment asset to which the user does not have access (i.e., an entertainment asset from a library of entertainment assets accessed, at 403, at a media service at which the user is not authenticated). If the particular entertainment asset selected by the user is an entertainment asset to which the user does not have access, method 400 proceeds to act 406. If the particular entertainment asset selected by the user is an entertainment asset to which the user does have access, method 400 skips act 406 and proceeds directly to act 407. Act 406 is therefore an optional act in method 400 that depends on the particular entertainment asset selected by the user at 405.

At optional act 406, which is only carried out if the particular entertainment asset selected by the user at 405 is an entertainment asset to which the user does not have access, the user is prompted to log in to or create an account at the media service at which the particular entertainment asset is accessible and at which the user is not authenticated. This is because, in the illustrative example of method 400, the user cannot retrieve/access individual entertainment assets without being authenticated at the media service(s) at which such entertainment assets are accessible.

At 407, which is carried out after 406 in implementations in which 406 is performed or carried out directly after act 405 in implementations in which the particular entertainment asset selected by the user at 405 is an entertainment asset to which the user does have access, the particular entertainment asset that was selected by the user at 405 is provided to the user. Depending on the specific implementation (e.g., depending on the form/nature of the particular entertainment asset selected by the user and depending on the manner in which the corresponding media service provides entertainment assets to users), at 407 the particular entertainment asset may be provided to the user by any of: enabling the user to download and execute, play, or otherwise deploy the particular entertainment asset; streaming or otherwise deploying the particular entertainment asset to the user remotely; or otherwise enabling the user to execute, play, or deploy the particular entertainment asset.

As previously described, any or all of methods 100, 200, 300, and/or 400 may be implemented on or performed by a computer or computerized system as a “computer-implemented” method, in which the “displaying” acts may generally involve or invoke a user interface displayed on an electronic display. While not intended to limit the character, style, or presentation in any way, the present disclosure includes illustrative examples of various user interfaces to demonstrate certain implementations of the systems, devices, and methods.

FIG. 5 is an illustrative diagram of a user interface 500 that demonstrates an exemplary instance of the present systems, devices, and methods. Specifically, user interface 500 provides an illustrative example of act 404 from method 400. User interface 500 is displayed on a display 501, which may be a television screen, a smart television screen, a computer monitor, a laptop monitor, or a screen of another electronic device such as a tablet computer, a smartphone, or the like.

In accordance with the present systems, devices, and methods, user interface 500 includes a display of the respective titles of a portion of an aggregate library of entertainment assets: Movie V, Movie W, Movie X, Movie Y, and Movie Z all under the heading “Movie Comedies” and Song 1, Song 2, Song 3, Song 4, and Song 5 all under the heading “Popular Music.” Thus, in the implementation of user interface 500 the aggregate library of entertainment assets being explored includes movie assets and song assets, or in other words, includes assets of different types, namely, video assets and audio assets. In other implementations, the aggregate library of entertainment assets may be limited to assets of a single type, such as video assets or audio assets. In addition to the titles of the assets themselves, user interface 500 also marks or annotates each title with the corresponding media service(s) at which the title is accessible. For example, Movie V is marked with “Media Service A” to indicate that Movie V is accessible at Media Service A, whereas Movie Y is marked with “Media Service B” and “Media Service C” to indicate that Movie Y is accessible at both Media Service B and at Media Service C.

User interface 500 provides a specific example of act 404 of method 400 that includes sub-acts 404a and 404b. That is, user interface 500 includes a display of two entertainment assets, Movie X and Song 2, that are accessible at respective media services, Media Service C and Media Service E as annotated, at which the user is not authenticated. Because the user is not authenticated at Media Service C and Media Service E, the user cannot immediately access or retrieve entertainment assets from Media Service C and Media Service E. To convey this limitation to the user, user interface 500 further marks or annotates Movie X and Song 2 with a conventional “no entry” symbol. In this way, the user is able to see and explore which assets are available at Media Service C and Media Service E without actually having an account at Media Service C or at Media Service E. This limited exploration capability enables the user to compare the offerings (i.e., respective libraries of entertainment assets) of different media services to make informed decisions about at which media service(s) the user would like to purchase a subscription. Furthermore, this limited exploration capability enables the media services themselves to present their offerings (i.e., respective libraries of entertainment assets) to users and advantageously highlight or draw attention to instances where they can offer access to a particular entertainment asset that a competitor cannot. In the present example of user interface 500, Media Service C is able to convey to the user that Movie X is accessible at Media Service C. The user is able to see that Movie X is available at Media Service C (at which the user is not authenticated because, for example, the user does not have an account at Media Service C) and that Movie X is not available at Media Services A, B, D, or E where the user has authenticated. Thus, if the user highly values Movie X, the user may elect to establish (e.g., purchase) an account at Media Service C to the mutual benefit of the user and Media Service C.

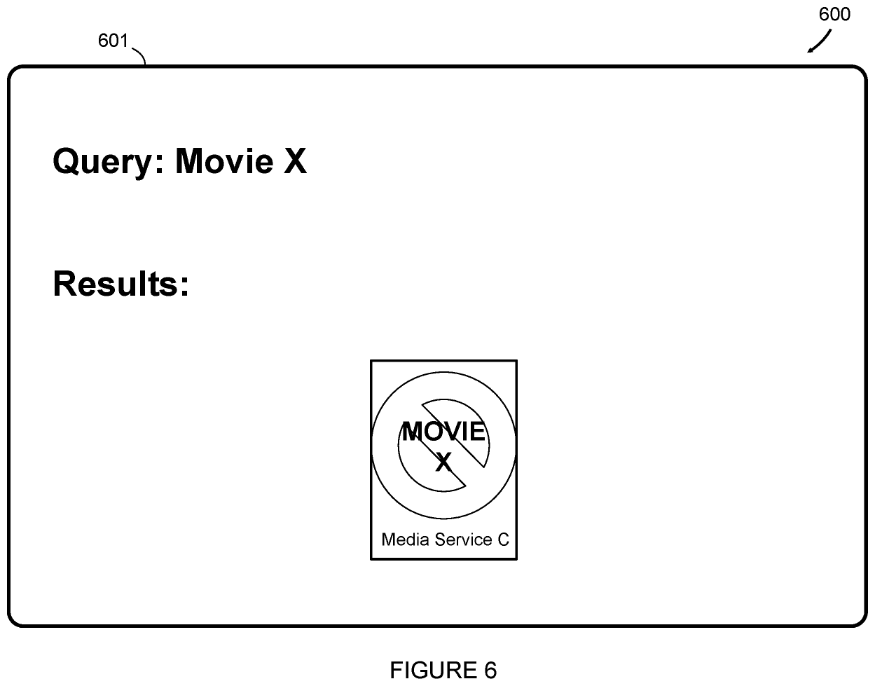

User interface 500 represents an instance of the present systems, devices, and methods in which a portion of an aggregate library of entertainment assets is displayed to a user in “exploration” or “navigation” mode, wherein the user has not entered or provided a specific query. An example of a user interface displaying query results is shown in FIG. 6.

FIG. 6 is an illustrative diagram of a user interface 600 that demonstrates an exemplary instance of the present systems, devices, and methods. Specifically, user interface 600 provides an illustrative example of act 202 from method 200 in which sub-act 202a is carried out before act 202. Like user interface 500, user interface 600 is displayed on a display 601.

At the instance of user interface 600 shown in FIG. 6, a query for Movie X has been received from the user and a result, namely an asset corresponding to Movie X, is retrieved from the aggregate library of entertainment assets and displayed to the user. Exemplary user interface 600 employs the same aggregate library of entertainment assets and the same authentication information as user interface 500 from FIG. 5, therefore the result of the user's query for Movie X displayed in user interface 600 includes an annotation providing the identity of a media service (i.e., Media Service C) at which Movie X is accessible and, because the user is not authenticated at Media Service C, an indication (i.e., “no entry” symbol) that Movie X is not immediately accessible to the user.

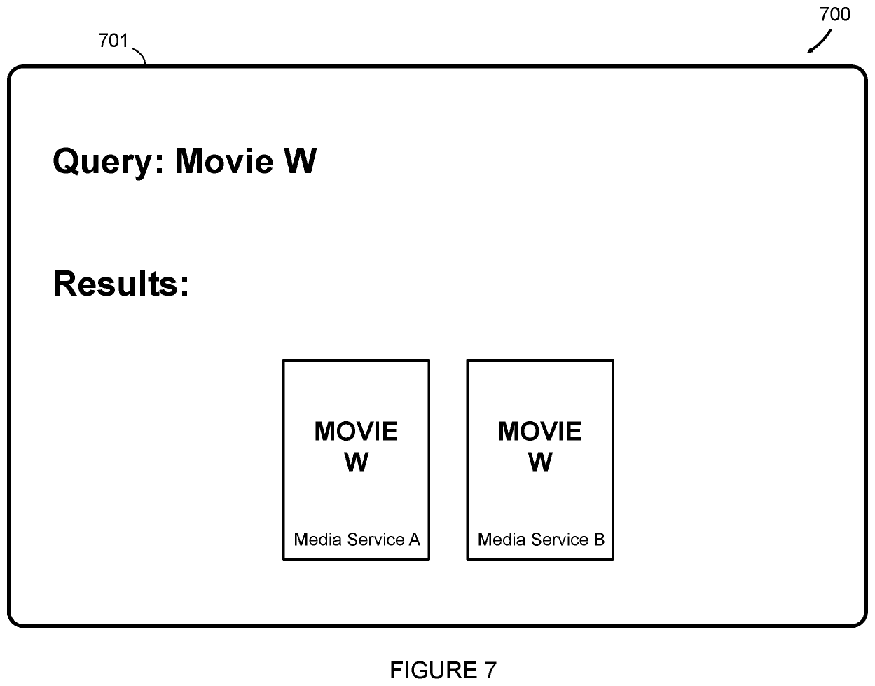

FIG. 7 is an illustrative diagram of a user interface 700 that demonstrates another exemplary instance of the present systems, devices, and methods. Specifically, user interface 700 provides an illustrative example of a display of a result of a query received from the user when the result is an entertainment asset that is accessible at multiple media service at which the user is authenticated. Like user interface 600 and user interface 500, user interface 700 is displayed on a display 701.

At the instance of user interface 700 shown in FIG. 7, a query for Movie W has been received from the user and a result, namely an asset corresponding to Movie W, is retrieved from the aggregate library of entertainment assets and displayed to the user. Exemplary user interface 700 employs the same aggregate library of entertainment assets and the same authentication information as user interface 500 from FIG. 5 and user interface 600 from FIG. 6, therefore the result of the user's query for Movie W displayed in user interface 700 includes annotations providing the identities of two media services (i.e., Media Service A and Media Service B) at which Movie W is accessible. In exemplary user interface 700, two instances of Movie W are separately displayed, one corresponding to the instance of Movie W accessible at Media Service A and one corresponding to the instance of Movie W accessible at Media Service B. This way, the user may choose at which media service (i.e., Media Service A or Media Service B) to access Movie W. The user is authenticated at both Media Service A and Media Service B, therefore neither instance includes an indication (i.e., “no entry” sign) that Movie W is not accessible. In alternative implementations, the result to the query for Movie W may display a single instance with an indication that Movie W is available at multiple media services and, if the user proceeds to view or access Movie W, a default media service may be selected based on a preconfigured user setting, or the user may be prompted to choose at which media service the user would like to access Movie W.

The various implementations described herein often make reference to “computer-based,” “computer-implemented,” “at least one processor,” “a non-transitory processor-readable storage medium,” and similar computer-oriented terms. A person of skill in the art will appreciate that the present systems, devices, and methods may be implemented using or in association with a wide range of different hardware configurations, including localized hardware configurations (e.g., a desktop computer, laptop, smartphone, smart tv, digital media player, or similar) and/or distributed hardware configurations that employ hardware resources located remotely relative to one another and communicatively coupled through a network, such as a cellular network or the internet. For the purpose of illustration, an exemplary computer system suitable for implementing the present systems, devices, and methods is provided in FIG. 8.

FIG. 8 is an illustrative diagram of a processor-based computer system 800 suitable at a high level for enabling a user to explore and access entertainment assets at multiple media services in accordance with the present systems, devices, and methods. Although not required, some portion of the implementations are described herein in the general context of data, processor-executable instructions or logic, such as program application modules, objects, or macros executed by one or more processors. Those skilled in the art will appreciate that the described implementations, as well as other implementations, can be practiced with various processor-based system configurations, including handheld devices, such as smartphones and tablet computers, digital media systems, multiprocessor systems, microprocessor-based or programmable consumer electronics, personal computers (“PCs”), network PCs, minicomputers, mainframe computers, and the like.

Processor-based computer system 800 includes at least one processor 801, a non-transitory processor-readable storage medium or “system memory” 802, and a system bus 810 that communicatively couples various system components including the system memory 802 to the processor(s) 801. Processor-based computer system 801 is at times referred to in the singular herein, but this is not intended to limit the implementations to a single system, since in certain implementations there will be more than one system or other networked computing device(s) involved. Non-limiting examples of commercially available processors include, but are not limited to: Core microprocessors from Intel Corporation, U.S.A., PowerPC microprocessor from IBM, ARM processors from a variety of manufacturers, Sparc microprocessors from Sun Microsystems, Inc., PA-RISC series microprocessors from Hewlett-Packard Company, and 6xxx series microprocessors from Motorola Corporation.

The processor(s) 801 of processor-based computer system 800 may be any logic processing unit, such as one or more central processing units (CPUs), microprocessors, digital signal processors (DSPs), application-specific integrated circuits (ASICs), field programmable gate arrays (FPGAs), and/or the like. Unless described otherwise, the construction and operation of the various blocks shown in FIG. 8 may be presumed to be of conventional design. As a result, such blocks need not be described in further detail herein as they will be understood by those skilled in the relevant art.

The system bus 810 in the processor-based computer system 800 may employ any known bus structures or architectures, including a memory bus with memory controller, a peripheral bus, and/or a local bus. The system memory 802 includes read-only memory (“ROM”) 821 and random access memory (“RAM”) 822. A basic input/output system (“BIOS”) 823, which may or may not form part of the ROM 821, may contain basic routines that help transfer information between elements within processor-based computer system 800, such as during start-up. Some implementations may employ separate buses for data, instructions and power.

Processor-based computer system 800 (e.g., system memory 802 thereof) may include one or more solid state memories, for instance, a Flash memory or solid state drive (SSD), which provides nonvolatile storage of processor-executable instructions, data structures, program modules and other data for processor-based computer system 800. Although not illustrated in FIG. 8, processor-based computer system 800 may, in alternative implementations, employ other non-transitory computer- or processor-readable storage media, for example, a hard disk drive, an optical disk drive, or a memory card media drive.

Program modules in processor-based computer system 800 may be stored in system memory 802, such as an operating system 824, one or more application programs 825, program data 826, other programs or modules 827, and drivers 828. In some implementations, application programs 825 may include respective application programs each corresponding to a respective media service (e.g., a Netflix app, an Amazon Prime app, a Disney+ app, and the like).

The system memory 802 in processor-based computer system 800 may also include one or more communications program(s) 829, for example, a server and/or a Web client or browser for permitting processor-based computer system 800 to access and exchange data with other systems such as user computing systems, Web sites on the Internet, corporate intranets, or other networks as described below. The communications program(s) 829 in the depicted implementation may be markup language based, such as Hypertext Markup Language (HTML), Extensible Markup Language (XML) or Wireless Markup Language (WML), and may operate with markup languages that use syntactically delimited characters added to the data of a document to represent the structure of the document. A number of servers and/or Web clients or browsers are commercially available such as those from Google (Chrome), Mozilla (Firefox), Apple (Safari), and Microsoft (Internet Explorer).

While shown in FIG. 8 as being stored locally in system memory 802, operating system 824, application programs 825, program data 826, other programs/modules 827, drivers 828, and communication program(s) 829 may be stored and accessed remotely through a communication network or stored on any other of a large variety of non-transitory processor-readable media (e.g., hard disk drive, optical disk drive, SSD and/or flash memory).

Processor-based computer system 800 may include one or more interface(s) to enable and provide interactions with a user, peripheral device(s), and/or one or more additional processor-based computer system(s). As an example, processor-based computer system 800 includes interface 830 to enable and provide interactions with a user of processor-based computer system 800. A user of processor-based computer system 800 may enter commands, instructions, data, and/or information via, for example, input devices 831 such as computer mouse, keyboard, microphone, remote control, and/or touchscreen. Other input devices may include a joystick, game pad, tablet, scanner, biometric scanning device, wearable input device, and the like. These and other input devices (i.e., “I/O devices”) are communicatively coupled to processor(s) 801 through interface 830, which may include one or more universal serial bus (“USB”) interface(s) that communicatively couples user input to the system bus 810, although other interfaces such as a parallel port, a game port or a wireless interface or a serial port may be used. A user of processor-based computer system 800 may also receive information output by processor-based computer system 800 through interface 830, such as visual information displayed by a display 832 and/or audio information output by one or more speaker(s) (not shown). Display 832 may, in some implementations, include a touch screen.

As another example of an interface, processor-based computer system 800 includes communication interface 840 to enable processor-based computer system 800 to operate in a networked environment using one or more of the logical connections to communicate with one or more remote computers, servers and/or devices (collectively, the “Cloud” 841) via one or more communications channels. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, communication interface 840 may include one or more wired or wireless communications interfaces, such as network interface controllers, cellular radios, WI-FI radios, and/or Bluetooth radios for establishing communications with the Cloud 841, for instance, the Internet or a cellular network.

In a networked environment, program modules, application programs or data, or portions thereof, can be stored in a server computing system (not shown). Those skilled in the relevant art will recognize that the network connections shown in FIG. 8 are only some examples of ways of establishing communications between computers, and other connections may be used, including wirelessly.

For convenience, processor(s) 801, system memory 802, interface 830, and communication interface 840 are illustrated as communicatively coupled to each other via the system bus 810, thereby providing connectivity between the above-described components. In alternative implementations, the above-described components may be communicatively coupled in a different manner than illustrated in FIG. 8. For example, one or more of the above-described components may be directly coupled to other components, or may be coupled to each other via intermediary components (not shown). In some implementations, system bus 810 may be omitted with the components all coupled directly to each other using suitable connections.

In accordance with the present systems, devices, and methods, processor-based computer system 800 may be used to implement any or all of methods 100, 200, 300, and/or 400 described herein, and/or provide any of the user interactions/interfaces described herein, including without limitation user interfaces 500, 600, and/or 700. Where the descriptions of methods 100, 200, 300 and 400 make reference to an act being performed by at least one processor, such act may be performed by processor(s) 801 of computer system 800. Where the descriptions of methods 100, 200, 300, and 400 make reference an act being performed by, performed on, or otherwise involving a non-transitory processor-readable storage medium, such act may be performed by, performed on, or otherwise involve system memory 802 of computer system 800.

Computer system 800 is an illustrative example of a system for enabling a user to explore and interact with entertainment assets at multiple media services, the system comprising at least one processor 801, at least one non-transitory processor-readable storage medium 802 communicatively coupled to the at least one processor 801 (e.g, by system bus 810), and the various other hardware and software components illustrated in FIG. 8 (e.g., operating system 824, input 831, etc.). In particular, in order to enable system 800 to implement the present systems, devices, and methods, system memory 802 stores a computer program product 850 comprising data and/or processor-executable instructions 851 that, when executed by processor(s) 801, cause system 800 to perform the various acts of methods 100, 200, 300, and/or 400 as described herein. Using method 100 as an example, the data and/or processor-executable instructions 851 of computer program product 850 stored in system memory 802 may, when executed by processor(s) 801, cause communication interface 840 to access a respective library of entertainment assets at each respective media service in a set of media services per act 101 of method 100, and cause display 832 to display to the user at least a portion of an aggregate library of entertainment assets per act 102 of method 100. In response to receiving (e.g., via input 831) a selection from the user of a particular entertainment asset from the aggregate library of entertainment assets per act 103 of method 100, data and/or processor-executable instructions 851 of computer program product 850, when executed by processor(s) 801, cause communication interface 840 to access the particular entertainment asset at a particular media service in the set of media services at which the particular entertainment asset is accessible per act 104 of method 100.

Throughout this specification and the appended claims, the term “computer program product” is used to refer to a package, combination, or collection of software comprising processor-executable instructions and/or data that may be accessed by (e.g., through a network such as cloud 841) or distributed to and installed on (e.g., stored in a local non-transitory processor-readable storage medium such as system memory 802) a computer system (e.g., computer system 800) in order to enable certain functionality (e.g., application(s), program(s), and/or module(s)) to be executed, performed, or carried out by the computer system.

In some implementations of the present systems, devices, and methods, computer program product 850 may be completely or partially self-sufficient and self-contained in the sense that, in some implementations, computer program product 850 may contain sufficient data and/or processor-executable instructions 851 to perform (or cause computer system 800 to perform) all or most of the acts of the various methods described herein. For example, computer program product 850 may store locally, in memory 802, a copy of the aggregate library of entertainment assets and respective copies of the entertainment assets themselves, and computer program product may include the data and/or processor-executable instructions 851 necessary to deploy entertainment assets directly. Alternatively, computer program product 850 may store library data only (e.g., asset titles, but not assets themselves) and may include data and/or processor-executable instructions 851 necessary to retrieve entertainment assets based on library data. However, in alternative implementations computer program product 850 may invoke and/or rely upon other data and/or processor-executable instructions outside of computer program product 850 in order to cause the various acts described herein to be carried out.

For example, in some implementations the respective libraries of entertainment assets accessible at each media service may be stored remotely at the media services themselves and computer program product 850 may store little to no information about the aggregate library of entertainment assets locally. That is, Media Service A may operate a first host server system 861 that stores a first library (Library A) of entertainment assets 871, Media Service B may operate a second host server system 862 that stores a second library (Library B) of entertainment assets 872, and so on, up to Media Service N (where N is an integer greater than 2) that may operate an N^{th} host server system 863 that stores an N^{th} library (Library N) of entertainment assets 873. In this case, the aggregate library of entertainment assets corresponds to the combination of Library A, Library B, . . . , and Library N. This configuration has numerous advantages, including alleviating the burden of large amounts of local memory storage and placing the burden of keeping the respective libraries 871, 872, 873 up-to-date on the media services themselves.

As another example, in some implementations computer program product 850 may be incapable of providing, deploying, or executing entertainment assets itself but may instead rely upon or invoke one or more other software applications or programs (e.g., application programs 825) to do so. That is, computer program product 850 may include a video player operative to play a movie from the library of Netflix or any other streaming video service, but alternatively computer program product 850 may not include a video player and, instead, data and/or processor-executable instructions 851 may provide a video asset to a user by launching or opening (e.g, per sub-act 304a of method 300) a separate application program 825 (such as a Netflix app or similar) and causing (e.g., per sub-act 304b of method 300) such separate application program to play the video asset.

The various embodiments described herein provide systems, devices, and methods for enabling a user to explore and access entertainment assets at multiple media services. More specifically, the various embodiments described herein provide systems, devices, and methods for “entertainment asset aggregation” that enable a user to explore the respective libraries of entertainment assets available at multiple media services substantially concurrently or “all in one place” and to easily access a selected entertainment asset from any one of the multiple media services. Online service providers of multimedia entertainment, such as streaming video service providers like Netflix and Amazon Prime, are a relatively new resource and their diversity and number is growing rapidly today. The state of the art is accustomed to only a handful of online service providers, and/or a dominant online service provider having a library of entertainment assets that encompasses most assets of interest to the user. However, with more and more media services joining the industry offering a wider range of non-overlapping entertainment assets, a need in the art is developing for the present systems, devices, and methods for aggregating the offerings of the various media services. Such enables both users and media services alike to readily explore and compare libraries and results in overall better matching between users and media services.

Throughout this specification and the appended claims the term “communicative” as in “communicative coupling” and in variants such as “communicatively coupled,” is generally used to refer to any engineered arrangement for transferring and/or exchanging information. For example, a communicative coupling may be achieved through a variety of different media and/or forms of communicative pathways, including without limitation: electrically conductive pathways (e.g., electrically conductive wires, electrically conductive traces), magnetic pathways (e.g., magnetic media), wireless signal transfer (e.g., radio frequency antennae), and/or optical pathways (e.g., optical fiber). Exemplary communicative couplings include, but are not limited to: electrical couplings, magnetic couplings, radio frequency couplings, and/or optical couplings.

Throughout this specification and the appended claims, infinitive verb forms are often used. Examples include, without limitation: “to encode,” “to provide,” “to store,” and the like. Unless the specific context requires otherwise, such infinitive verb forms are used in an open, inclusive sense, that is as “to, at least, encode,” “to, at least, provide,” “to, at least, store,” and so on.

This specification, including the drawings and the abstract, is not intended to be an exhaustive or limiting description of all implementations and embodiments of the present systems, devices, and methods. A person of skill in the art will appreciate that the various descriptions and drawings provided may be modified without departing from the spirit and scope of the disclosure. In particular, the teachings herein are not intended to be limited by or to the illustrative examples of computer systems and computing environments provided.

This specification provides various implementations and embodiments in the form of block diagrams, schematics, flowcharts, and examples. A person skilled in the art will understand that any function and/or operation within such block diagrams, schematics, flowcharts, or examples can be implemented, individually and/or collectively, by a wide range of hardware, software, and/or firmware. For example, the various embodiments disclosed herein, in whole or in part, can be equivalently implemented in one or more: application-specific integrated circuit(s) (i.e., ASICs); standard integrated circuit(s); computer program(s) executed by any number of computers (e.g., program(s) running on any number of computer systems); program(s) executed by any number of controllers (e.g., microcontrollers); and/or program(s) executed by any number of processors (e.g., microprocessors, central processing units, graphical processing units), as well as in firmware, and in any combination of the foregoing.

Throughout this specification and the appended claims, a “memory” or “storage medium” is a processor-readable medium that is an electronic, magnetic, optical, electromagnetic, infrared, semiconductor, or other physical device or means that contains or stores processor data, data objects, logic, instructions, and/or programs. When data, data objects, logic, instructions, and/or programs are implemented as software and stored in a memory or storage medium, such can be stored in any suitable processor-readable medium for use by any suitable processor-related instruction execution system, apparatus, or device, such as a computer-based system, processor-containing system, or other system that can fetch the data, data objects, logic, instructions, and/or programs from the memory or storage medium and perform various acts or manipulations (i.e., processing steps) thereon and/or in response thereto. Thus, a “non-transitory processor-readable storage medium” can be any element that stores the data, data objects, logic, instructions, and/or programs for use by or in connection with the instruction execution system, apparatus, and/or device. As specific non-limiting examples, the processor-readable medium can be: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and/or any other non-transitory medium.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A method of enabling a user to explore and access entertainment assets at multiple media services, the method comprising:
accessing a respective library of entertainment assets at each respective media service in a set of media services;
displaying to the user at least a portion of an aggregate library of entertainment assets, the aggregate library of entertainment assets including each respective library of entertainment assets at each respective media service in the set of media services;
receiving from the user a selection of a particular entertainment asset from the aggregate library of entertainment assets; and
accessing the particular entertainment asset at a particular media service in the set of media services, the particular media service having a library of entertainment assets that includes the particular entertainment asset.

2. The method of claim 1, further comprising:
receiving a query from the user; and
retrieving at least one result of the query from the aggregate library of entertainment assets.

3. The method of claim 1 wherein accessing the particular entertainment asset at a particular media service in the set of media services includes opening an application corresponding to the particular media service and causing the application to access the particular entertainment asset.

4. The method of claim 1 wherein accessing the particular entertainment asset at a particular media service in the set of media services includes prompting the user to log in to or create an account at the particular media service.

5. The method of claim 1, further comprising:
authenticating the user at each media service in the set of media services; and
accessing at least one additional library of entertainment assets of at least one media service at which the user is not authenticated, wherein the aggregate library of entertainment assets further includes the at least one additional library of entertainment assets at the at least one media service at which the user is not authenticated, and wherein displaying to the user at least a portion of an aggregate library of entertainment assets includes:
displaying to the user at least one entertainment asset accessible at a media service at which the user is not authenticated; and
annotating the at least one entertainment asset accessible at a media service at which the user is not authenticated with an identification of the media service at which the at least one entertainment asset is accessible.

6. The method of claim 5 wherein receiving from the user a selection of a particular entertainment asset from the aggregate library of entertainment assets includes receiving from the user a selection of an entertainment asset accessible at a media service at which the user is not authenticated, the method further comprising:
prompting the user to log in to or create an account at the media service at which the user is not authenticated.

7. The method of claim 1 wherein accessing a respective library of entertainment assets at each respective media service in a set of media services includes accessing a first library of entertainment assets of a first type at a first media service and accessing a second library of entertainment assets of a second type at a second media service, the second type of entertainment assets different from the first type of entertainment assets such that the aggregate library of entertainment assets includes at least two different asset types.

8. A system for enabling a user to explore and access entertainment assets at multiple media services, the system comprising:
at least one processor;
a display communicatively coupled to the at least one processor;
a communication interface communicatively coupled to the at least one processor; and
a non-transitory processor-readable storage medium communicatively coupled to the at least one processor, the non-transitory processor-readable storage medium storing data and/or processor-executable instructions that, when executed by the at least one processor, cause:
the communication interface to access a respective library of entertainment assets at each respective media service in a set of media services;
the display to display to the user at least a portion of an aggregate library of entertainment assets, the aggregate library of entertainment assets including each respective library of entertainment assets at each respective media service in the set of media services; and
in response to receiving from the user a selection of a particular entertainment asset from the aggregate library of entertainment assets:
the communication interface to access the particular entertainment asset at a particular media service in the set of media services, the particular media service having a library of entertainment assets that includes the particular entertainment asset.

9. The system of claim 8 wherein the data and/or processor-executable instructions, when executed by the at least one processor, further cause, in response to receiving a query from the user, the communication interface to retrieve at least one result of the query from the aggregate library of entertainment assets.

10. The system of claim 8 wherein the non-transitory processor-readable storage medium further stores a respective application corresponding to each respective media service in the set of media services, and wherein the data and/or processor-executable instructions that, when executed by the at least one processor, cause the communication interface to access the particular entertainment asset at a particular media service in the set of media services, further cause:
the system to open a particular application corresponding to the particular media service; and
the particular application to access the particular entertainment asset.

11. The system of claim 8 wherein the data and/or processor-executable instructions that, when executed by the at least one processor, cause the communication interface to access the particular entertainment asset at a particular media service in the set of media services, further cause the display to prompt the user to log in to or create an account at the particular media service.

12. The system of claim 8 wherein the data and/or processor-executable instructions, when executed by the at least one processor, further cause the system to:
authenticate the user at each media service in the set of media services; and
access at least one additional library of entertainment assets of at least one media service at which the user is not authenticated, wherein the aggregate library of entertainment assets further includes the at least one additional library of entertainment assets at the at least one media service at which the user is not authenticated, and wherein the data and/or processor-executable instructions that, when executed by the at least one processor, cause the display to display to the user at least a portion of an aggregate library of entertainment assets, cause the display to:
display to the user at least one entertainment asset accessible at a media service at which the user is not authenticated; and
annotate the at least one entertainment asset accessible at a media service at which the user is not authenticated with an identification of the media service at which the at least one entertainment asset is accessible.

13. The system of claim 12 wherein in response to receiving from the user a selection of an entertainment asset accessible at a media service at which the user is not authenticated, the data and/or processor-executable instructions, when executed by the at least one processor, cause the display to prompt the user to log in to or create an account at the media service at which the user is not authenticated.

14. The system of claim 8 wherein the data and/or processor-executable instructions, when executed by the at least one processor, cause the communication interface to access a first library of entertainment assets of a first type at a first media service and access a second library of entertainment assets of a second type at a second media service, the second type of entertainment assets different from the first type of entertainment assets such that the the aggregate library of entertainment assets includes at least two different asset types.

15. A computer program product comprising:
processor-executable instructions and/or data that, when the computer program product is:
stored in a non-transitory processor-readable storage medium of a system comprising:
at least one processor;
a display communicatively coupled to the at least one processor;
a communication interface communicatively coupled to the at least one processor; and
the non-transitory processor-readable storage medium communicatively coupled to the at least one processor;
and
executed by the at least one processor, cause:
the communication interface to access a respective library of entertainment assets at each respective media service in a set of media services;
the display to display to the user at least a portion of an aggregate library of entertainment assets, the aggregate library of entertainment assets including each respective library of entertainment assets at each respective media service in the set of media services; and
in response to receiving from the user a selection of a particular entertainment asset from the aggregate library of entertainment assets:
the communication interface to access the particular entertainment asset at a particular media service in the set of media services, the particular media service having a library of entertainment assets that includes the particular entertainment asset.

16. The computer program product of claim 15 wherein the data and/or processor-executable instructions, when executed by the at least one processor, further cause, in response to receiving a query from the user, the communication interface to retrieve at least one result of the query from the aggregate library of entertainment assets.

17. The computer program product of claim 15 wherein the data and/or processor-executable instructions that, when executed by the at least one processor, cause the communication interface to access the particular entertainment asset at a particular media service in the set of media services, further cause:
the computer program product to open an application corresponding to the particular media service; and
the application to access the particular entertainment asset.

18. The computer program product of claim 15 wherein the data and/or processor-executable instructions that, when executed by the at least one processor, cause the communication interface to access the particular entertainment asset at a particular media service in the set of media services, further cause the display to prompt the user to log in to or create an account at the particular media service.

19. The computer program product of claim 15 wherein the data and/or processor-executable instructions, when executed by the at least one processor, further cause the system to:
authenticate the user at each media service in the set of media services; and
access at least one additional library of entertainment assets of at least one media service at which the user is not authenticated, wherein the aggregate library of entertainment assets further includes the at least one additional library of entertainment assets at the at least one media service at which the user is not authenticated, and wherein the data and/or processor-executable instructions that, when executed by the at least one processor, cause the display to display to the user at least a portion of an aggregate library of entertainment assets, cause the display to:
display to the user at least one entertainment asset accessible at a media service at which the user is not authenticated; and
annotate the at least one entertainment asset accessible at a media service at which the user is not authenticated with an identification of the media service at which the at least one entertainment asset is accessible.

20. The computer program product of claim 19 wherein in response to receiving from the user a selection of an entertainment asset accessible at a media service at which the user is not authenticated, the data and/or processor-executable instructions, when executed by the at least one processor, cause the display to prompt the user to log in to or create an account at the media service at which the user is not authenticated.
